(19) United States
(12) Patent Application Publication
(10) Pub. No.: US 2024/0039376 A1
(43) Pub. Date: Feb. 1, 2024

(54) METHOD OF MANUFACTURING LAMINATED CORE

(71) Applicant: TOYOTA JIDOSHA KABUSHIKI KAISHA, Aichi-ken (JP)

(72) Inventors: Tomoyuki MAEDA, Toyota-shi (JP); Shinobu ISHIDA, Toyota-shi (JP)

(21) Appl. No.: 18/357,157

(22) Filed: Jul. 24, 2023

(30) Foreign Application Priority Data
Jul. 26, 2022 (JP) 2022-118592

(51) Int. Cl. H02K 15/02

(52) U.S. Cl. CPC H02K 15/02; H02K 2215/00; H02K 2201/09

(57) ABSTRACT

A method of manufacturing a laminated core in which an adhesive can be easily applied to gaps between laminated electromagnetic steel plates is provided. A method of manufacturing a laminated core according to the present disclosure includes a first step, a second step, and a third step. In the first step, an electromagnetic steel plate laminate is formed by laminating a plurality of electromagnetic steel plates in a lamination direction. In the second step, the electromagnetic steel plate laminate is excited in a direction intersecting the lamination direction. In the third step, an adhesive is applied to gaps between the plurality of electromagnetic steel plates in the electromagnetic steel plate laminate.

### CROSS REFERENCE TO RELATED APPLICATIONS

This application is based upon and claims the benefit of priority from Japanese patent application No. 2022-118592, filed on Jul. 26, 2022, the disclosure of which is incorporated herein in its entirety by reference.

### BACKGROUND

The present disclosure relates to a method of manufacturing a laminated core.

Japanese Unexamined Patent Application Publication No. 2019-022341 discloses a method of manufacturing a laminated steel plate by laminating a plurality of steel plates as an example of a method of manufacturing such a laminated core. This method of manufacturing a laminated steel plate includes an application step of applying an adhesive to surfaces of the steel plates and a lamination step of laminating the steel plates to which an adhesive is applied and other steel plates around an axis at positions displaced from each other and then adhering the steel plates and a laminate to each other by the adhesive.

### SUMMARY

The inventors of the present application have discovered the following problem.

In this method of manufacturing a laminated core, the adhesive is applied to each of the steel plates, and then the plurality of steel plates are laminated. Therefore, the application step sometimes takes a long time. In order to address this issue, the inventors of the present application have conceived a method of manufacturing a laminated core in which a plurality of steel plates are laminated and then an adhesive is applied to gaps between the plurality of steel plates. However, the gaps between the plurality of steel plates are small, making it difficult to apply the adhesive.

The present disclosure has been made in view of the aforementioned problem, and provides a method of manufacturing a laminated core in which an adhesive can be easily applied to gaps between laminated electromagnetic steel plates.

A method of manufacturing a laminated core according to the present disclosure includes:
forming an electromagnetic steel plate laminate by laminating a plurality of electromagnetic steel plates in a lamination direction;
exciting the electromagnetic steel plate laminate in a direction intersecting the lamination direction; and
applying an adhesive to gaps between the plurality of electromagnetic steel plates in the electromagnetic steel plate laminate.

According to such a configuration, after the electromagnetic steel plate laminate is excited in the direction intersecting the lamination direction, the adhesive is applied to the gaps between the plurality of electromagnetic steel plates. In this way, the adhesive can be applied easily to the gaps between the plurality of electromagnetic steel plates.

Further, in the exciting of the electromagnetic steel plate laminate in the above method,
the electromagnetic steel plate laminate may be excited in the direction intersecting the lamination direction, and the electromagnetic steel plates may be caused to repel each other, so that the gaps between the electromagnetic steel plates are increased.

According to such a configuration, after the electromagnetic steel plate laminate is excited in the direction intersecting the lamination direction, the gaps between the plurality of electromagnetic steel plates are increased, and then the adhesive is applied. In this way, the adhesive can be applied more reliably to the gaps between the plurality of electromagnetic steel plates.

Furthermore, in the forming of the electromagnetic steel plate laminate in the above method,
the electromagnetic steel plate laminate may be formed by laminating the plurality of electromagnetic steel plates and then caulking the plurality of laminated electromagnetic steel plates.

According to the present disclosure, it is possible to easily apply an adhesive to gaps between laminated electromagnetic steel plates.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a flowchart showing a method of manufacturing a laminated core according to a first embodiment;

FIG. 2A is a perspective view showing an example of the laminated core manufactured by the method of manufacturing a laminated core according to the first embodiment;

FIG. 2B is an overview diagram showing a first step in the method of manufacturing a laminated core according to the first embodiment;

FIG. 3A is a top view schematically showing an electromagnetic steel plate laminate after a first step in the method of manufacturing a laminated core according to the first embodiment is carried out;

FIG. 3B is a side view schematically showing the electromagnetic steel plate laminate after the first step in the method of manufacturing a laminated core according to the first embodiment is carried out;

FIG. 3C is a top view schematically showing the electromagnetic steel plate laminate after a second step is carried out;

FIG. 3D is a side view schematically showing an electromagnetic steel plate laminate after the second step is carried out;

FIG. 4 is an overview diagram for explaining a principle of separation of a plurality of electromagnetic steel plates in a second step ST2; and

FIG. 5 is a graph showing a relationship between temperature, gaps (penetration distance), and arrival time of an adhesive.

### DESCRIPTION OF EMBODIMENTS

Hereinafter, specific embodiments to which the present disclosure is applied will be described in detail with reference to the drawings. However, the present disclosure is not limited to the following embodiments. In addition, the following descriptions and drawings have been simplified as appropriate for clarity.

### (First Embodiment)

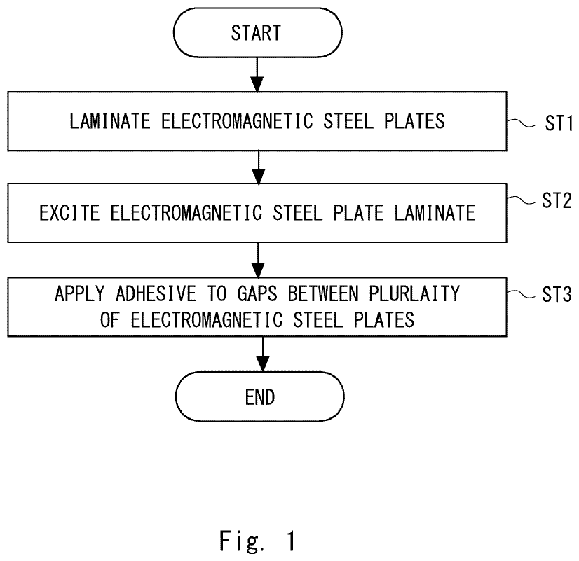

A method of manufacturing a laminated core according to a first embodiment will be described with reference to FIGS. 1 to 5. FIG. 1 is a flowchart showing the method of manufacturing a laminated core according to the first embodiment.

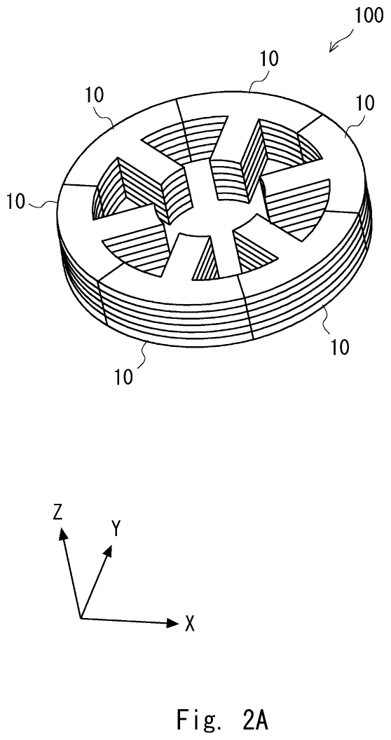

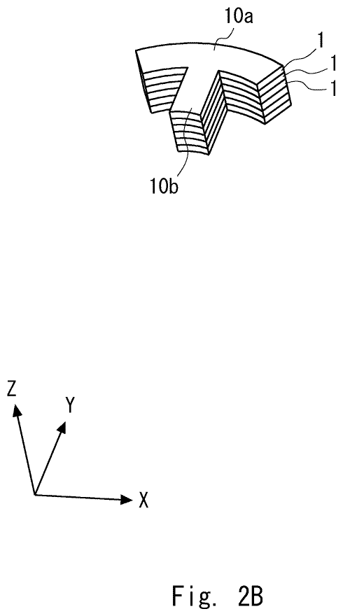

It should be noted that the right-handed XYZ coordinates shown in FIG. 2 and other drawings are for convenience in describing a positional relationship between the components. Normally, a Z axis direction is a lamination direction, and an XY plane is a principal plane of the electromagnetic steel plate 1, which are common among the drawings.

With the method of manufacturing a laminated core according to this first embodiment, a laminated core 100 shown in FIG. 2A can be manufactured. FIG. 2A is a perspective view showing an example of the laminated core manufactured by the method of manufacturing a laminated core according to the first embodiment. The laminated core 100 according to the first embodiment is a stator core, but may instead be a rotor core. The laminated core 100 includes a plurality of electromagnetic steel plate laminates 10. One example of the laminated core 100 shown in FIG. 2A includes six electromagnetic steel plate laminates 10. The six electromagnetic steel plate laminates 10 are arranged along a substantially circular shape.

First, a plurality of electromagnetic steel plates 1 are laminated in the lamination direction to form the electromagnetic steel plate laminate 10 (first step ST1). As shown in FIG. 2B, one example of the electromagnetic steel plate laminate 10 is a block body that is extended in an approximately T-shape and includes an arc-shaped part 10a that is extended in an arc shape and a projection The projection 10b projects from the vicinity of the center of the arc-shaped part 10a toward the center of the arc extending from the arc-shaped part 10a. The electromagnetic steel plate laminate 10 includes a plurality of laminated electromagnetic steel plates 1. FIG. 2B is an overview diagram showing the first step in the method of manufacturing a laminated core according to the first embodiment. For example, the electromagnetic steel plate 1 is a plate-like body that is extended in a substantially T-shape. An example of the electromagnetic steel plate laminate 10 shown in FIG. 2B is composed of six electromagnetic steel plates 1 laminated in the lamination direction (which is the Z direction in this case). However, the number of the electromagnetic steel plates 1 is not limited to six as long as it is plural.

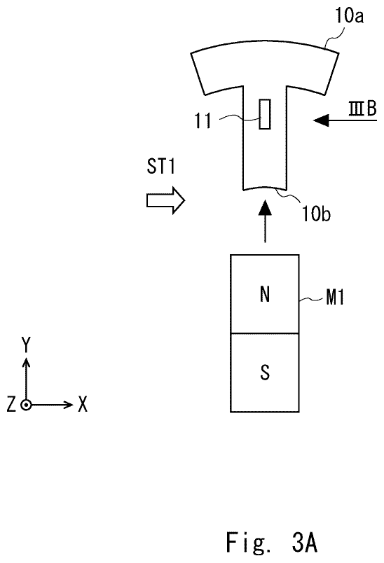

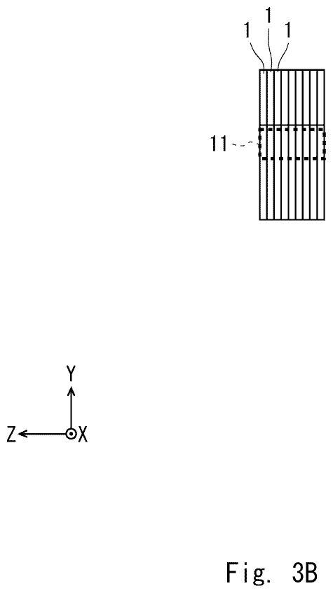

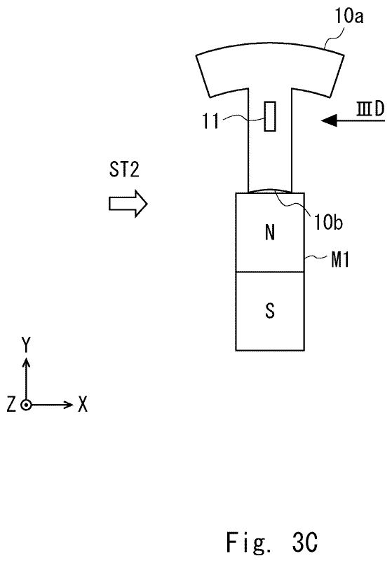

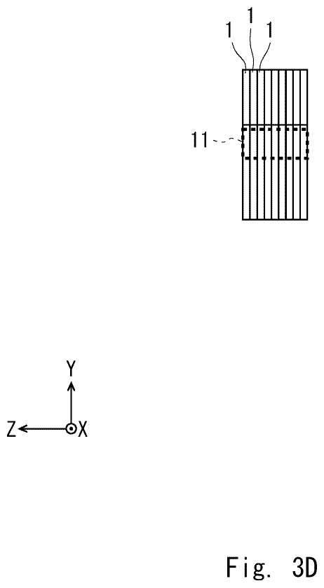

Specifically, it is preferable to form the electromagnetic steel plate laminate 10 by laminating the electromagnetic steel plates 1 in the lamination direction and then caulking these laminated electromagnetic steel plates 1. As shown in FIGS. 3A and 3B, the formed electromagnetic steel plate laminate 10 has a caulk part 11. FIG. 3A is a top view schematically showing the electromagnetic steel plate laminate 10 after the first step in the method of manufacturing a laminated core according to first embodiment is carried out. FIG. 3B is a side view of the electromagnetic steel plate laminate 10 shown in FIG. 3A. The caulk part 11 is composed of a plurality of electromagnetic steel plates 1 which are caulked and crimped to each other. The caulk part 11 temporarily holds the plurality of electromagnetic steel plates 1. For example, the plurality of electromagnetic steel plates 1 in the caulk part 11 may be pressed in the lamination direction and plastically deformed. In one example of the caulk part 11 shown in FIG. 3B, the caulk part 11 is provided in the vicinity of the center of the projection 10b of the electromagnetic steel plate laminate 10, but the caulk part 11 may be provided at any position of the electromagnetic steel plate laminate 10. There is almost no gap between the electromagnetic steel plates 1 in the caulked part 11. In addition, in order to ensure the shape accuracy of the electromagnetic steel plate laminate 10, there should be almost no gap between the electromagnetic steel plates 1 at the leading end of the projection 10b or the outer edge of the arc-shaped part 10a.

Next, as shown in FIGS. 3A to 3D, the electromagnetic steel plate laminate 10 is excited in a direction intersecting the lamination direction (second step ST2). FIG. 3C is a top view schematically showing the electromagnetic steel plate laminate 10 after the second step is carried out. FIG. 3D is a side view of the electromagnetic steel plate laminate 10 shown in FIG. 3C. Specifically, an N-pole of a permanent magnet M1 is brought close to or into contact with the leading end of the projection 10b of the electromagnetic steel plate laminate 10. Here, the permanent magnet M1 is a substantially rod-shaped body, and the N-pole and the S-pole are arranged side by side along an axial direction (which is the Y axis direction in this case) of the permanent magnet M1. More specifically, the N-pole of the permanent magnet M1 is brought close to the leading end of the projection 10b of the electromagnetic steel plate laminate 10 while a magnetization direction of the permanent magnet M1 is kept along the direction intersecting the lamination direction (which is a Y axis direction in this case). This direction intersecting the lamination direction may be, for example, the direction perpendicular to this lamination direction or, in FIGS. 3A to 3D, an X axis direction or the Y axis direction, or any direction other than the Z axis direction. When the electromagnetic steel plate laminate 10 is excited in the direction intersecting the lamination direction, the plurality of electromagnetic steel plates 1 are separated from each other.

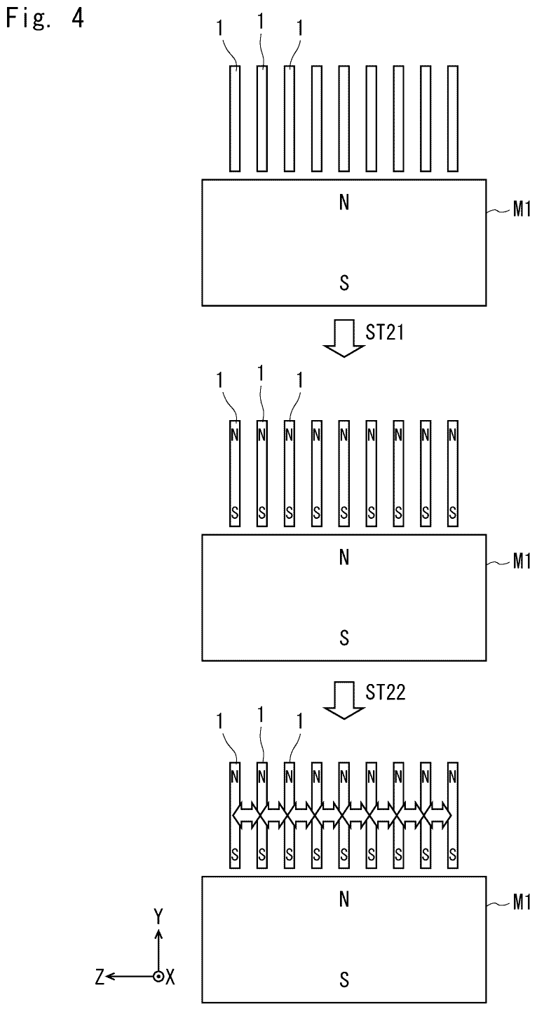

Here, a principle of the separation of the plurality of electromagnetic steel plates in the second step ST2 is described with reference to FIG. 4. FIG. 4 is an overview diagram for describing the principle of the separation of the plurality of electromagnetic steel plates.

As shown in FIG. 4, in the second step ST2, the permanent magnet M1 and the plurality of electromagnetic steel plates 1 are brought close to or into contact with each other (step ST21). Then, the plurality of electromagnetic steel plates 1 are excited (step ST22). The plurality of electromagnetic steel plates 1 are excited and have N-poles and S-poles. One end of each of the plurality of electromagnetic steel plates 1 is an N-pole while the other end thereof is an S-pole. Since the one end of each of the plurality of electromagnetic steel plates 1 is an N-pole, the one ends of the adjacent electromagnetic steel plates 1 receive a magnetic repulsion force from each other. Similarly, since the other end of each of the plurality of electromagnetic steel plates 1 is an S-pole, the other ends of the adjacent electromagnetic steel plates 1 receive a magnetic repulsion force from each other. Such a magnetic repulsion force causes the electromagnetic steel plates 1 to repel each other, thereby increasing the gaps between the electromagnetic steel plates 1. The electromagnetic steel plates 1 in the caulked part 11 are caulked and crimped to each other, while the electromagnetic steel plates 1 at the leading end of the projection 10b or the outer edge of the arc-shaped part 10a are not crimped to each other and are free. Therefore, the gaps between the electromagnetic steel plates 1 at the leading end of the projection 10b or the outer edge of the arc-shaped part 10a tend to become wider than the gaps between the electromagnetic steel plates 1 in the caulked part 11. The size of the gaps between the electromagnetic steel plates 1 should be determined by appropriately adjusting the specifications of the caulked part 11, the rigidity of the electromagnetic steel plates 1, and the magnetic forces of the electromagnetic steel plates 1.

Lastly, an adhesive is applied to the gaps between the electromagnetic steel plates 1 in the electromagnetic steel plate laminate 10 (third step ST3). Since the electromagnetic steel plates 1 are separated from each other in the second step ST2, the adhesive can be easily applied to the gaps between the electromagnetic steel plates 1.

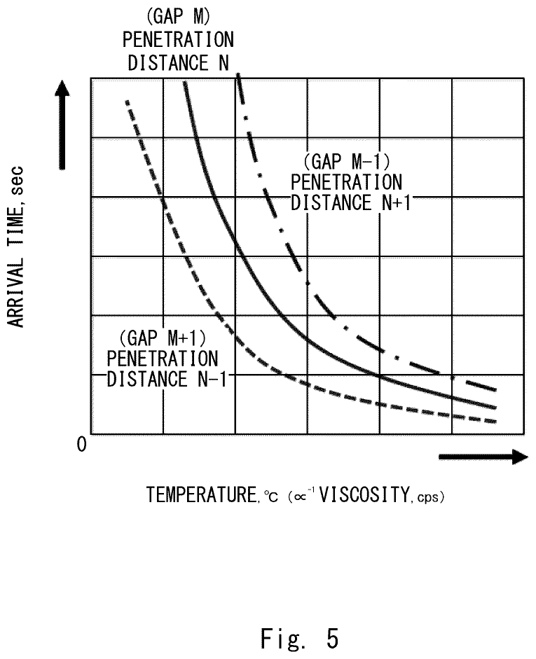

Here, the relation between the temperature of the adhesive, the gaps (penetration distance), and the arrival time shown in FIG. 5 is described. FIG. 5 is a graph showing the relationship between the temperature of the adhesive, the gaps (penetration distance), and the arrival time.

As shown in FIG. 5, the relationship between the temperature of the adhesive and the arrival time is generally inversely proportional. In addition, the arrival time tends to become shorter when the temperature of the adhesive increases, that is, when the viscosity of the adhesive is low. On the other hand, in many cases, since the adhesive is a thermosetting adhesive, if the temperature of the adhesive increases too much, the curing reaction will be excessively advanced. Therefore, the temperature of the adhesive is set within a predetermined range. As shown in FIG. 5, when the temperature of the adhesive is constant, the larger the gaps are, the shorter the arrival time tends to become. Therefore, when the gaps between the plurality of electromagnetic steel plates 1 increase, the arrival time of the adhesive is shortened, which is advantageous.

It should be noted that after the third step ST3, each of the plurality of electromagnetic steel plate laminates 10 is impregnated. After that, by assembling the plurality of electromagnetic steel plate laminates 10, the laminated core 100 shown in FIG. 2A is formed. Specifically, after the third step ST3, the electromagnetic steel plate laminate 10 may be impregnated as it is or the electromagnetic steel plate laminate 10 may be placed in a thermostatic furnace and impregnated, for example, by heating and holding the electromagnetic steel plate laminate 10 at 50 degrees C. Furthermore, after the electromagnetic steel plate laminate 10 is impregnated, the electromagnetic steel plate laminate may be fixed to a required shape while being pressurized to remove an excess adhesive protruding from the gaps between the plurality of electromagnetic steel plates 1. After that, the electromagnetic steel plate laminate 10 may be heated and held at, for example, 100 degrees C. to harden the adhesive.

As described above, according to the method of manufacturing a laminated core of the first embodiment, after the electromagnetic steel plate laminate 10 is excited in the lamination direction, the adhesive is applied to the gaps between the plurality of electromagnetic steel plates 1. Thus, the adhesive can be easily applied to the gaps between the plurality of electromagnetic steel plates 1.

In the second step in the method of manufacturing a laminated core according to the first embodiment, the electromagnetic steel plate laminate 10 is excited in the direction intersecting the lamination direction. By doing so, the plurality of electromagnetic steel plates 1 are made to repel each other, thereby increasing the gaps between the plurality of electromagnetic steel plates 1. Therefore, after the electromagnetic steel plate laminate is excited in the direction intersecting the lamination direction, the gaps between the plurality of electromagnetic steel plates 1 are increased, and then the adhesive is applied. In this way, the adhesive can be applied more reliably to the gaps between the plurality of electromagnetic steel plates 1.

In the first step according to the first embodiment, the plurality of electromagnetic steel plates 1 are laminated, and the laminated plurality of electromagnetic steel plates 1 are caulked to form the electromagnetic steel plate laminate 10. As a result, the gaps between the plurality of electromagnetic steel plates 1 at the leading end of the projection 10b and the outer edge of the arc-shaped part 10a tend to be increased compared with the gaps between the plurality of electromagnetic steel plates 1 in the vicinity of the caulked part 11. Therefore, the adhesive can be easily applied to the gaps between the plurality of electromagnetic steel plates 1 at the leading end of the projection 10b and the outer edge of the arc-shaped part 10a. Moreover, the gaps between the plurality of electromagnetic steel plates are secured while the electromagnetic steel plate laminate 10 is being integrated. Therefore, the handling of the electromagnetic steel plate laminate 10 is easy.

It should be noted that the present disclosure is not limited to the above embodiments, and appropriate changes can be made without departing from the scope. In addition, the present disclosure may be carried out by combining the above embodiments and an example thereof as appropriate. For example, in the second step ST2 shown in FIGS. 3A to 3D, the permanent magnet M1 is used, but an electromagnet may be used instead. Also, in the second step ST2, the N-pole of the permanent magnet M1 is brought close to the leading end of the projection 10b of the electromagnetic steel plate laminate 10 while the magnetization direction of the permanent magnet M1 is kept along the direction intersecting the lamination direction. Alternatively, the S-pole of the permanent magnet M1 may be brought close to the leading end of the projection 10b of the electromagnetic steel plate laminate 10. In addition, the permanent magnet M1 may be brought close to the part other than the leading end of the projection 10b of the electromagnetic steel plate laminate 10. For example, the permanent magnet M1 may be brought close to the outer edge side of the arc-shaped part 10a.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method of manufacturing a laminated core comprising:
forming an electromagnetic steel plate laminate by laminating a plurality of electromagnetic steel plates in a lamination direction;
exciting the electromagnetic steel plate laminate in a direction intersecting the lamination direction; and
applying an adhesive to gaps between the plurality of electromagnetic steel plates in the electromagnetic steel plate laminate.

2. The method according to claim 1, wherein
in the exciting of the electromagnetic steel plate laminate,
the electromagnetic steel plate laminate is excited in the direction intersecting the lamination direction, and the electromagnetic steel plates are caused to repel each other, so that the gaps between the electromagnetic steel plates are increased.

3. The method according to claim 1, wherein
in the forming of the electromagnetic steel plate laminate, the electromagnetic steel plate laminate is formed by laminating the plurality of electromagnetic steel plates and then caulking the plurality of laminated electromagnetic steel plates.
